(19) United States
(12) Patent Application Publication
(10) Pub. No.: US 2011/0090965 A1
(43) Pub. Date: Apr. 21, 2011

(54) Generation of Synchronized Bidirectional Frames and Uses Thereof

(75) Inventors: Yui Lam CHAN, Kowloon (HK); Changhong FU, Kowloon (HK); Wan-Chi SIU, New Territories (HK); Wai Lam HUI, New Territories (HK); Ka Man CHENG, Kowloon (HK); Yu LIU, New Territories (HK); Yan HUO, Shenzhen (CN)

(73) Assignee: Hong Kong Applied Science and Technology Research Institute Company Limited, New Teritories (HK)

(21) Appl. No.: 12/603,183

(22) Filed: Oct. 21, 2009

(51) Int. Cl. H04N 7/26

(52) U.S. Cl. 375/240.16; 375/E07.104

(57) ABSTRACT

A digital video processing method implementable on an apparatus, comprising performing on a reconstructed digital video frame, by a processor, a transform 110, a quantization 121, a dequantization 122 and an inverse transform 123 to convert a digital video bitstream with hierarchical B frame structure into a digital video bitstream with a modified hierarchical B frame structure. Bidirectional frames are used as access points via synchronized independent frames to enable applications including single view access in multi-view coding videos and random accessing frames. Improved bitstream switching methods are also disclosed.

### TECHNICAL FIELD

The claimed invention relates generally to video processing. In particular, the claimed invention relates to a method and apparatuses for video encoding and decoding. With greater particularity, the claimed invention relates to a new frame type in a digital video that uses bidirectional frames.

### SUMMARY OF THE INVENTION

Video communications are getting more and more prevalent nowadays. People enjoy videos whenever and wherever they are, over whatever networks and on all sorts of devices. There are increasingly higher expectations of the performance of video communications such as video quality, resolution, smoothness, yet network or device constraints such as bandwidth pose a challenge. The more efficient the video coding, the easier it is to meet such expectations. Video coding and video compression are described in Yun Q. Shi, Huifang Sun, Image and video compression for multimedia engineering: fundamentals, algorithms, and standards, (CRC Press, Boca Raton), c. 2008, L. Hanzo, et al., Video compression and communications: from basics to H.261, H.263, H.264, MPEG2, MPEG4 for DVB and HSDPA-style adaptive turbo-transceivers, (IEEE Press: J. Wiley & Sons, NJ), c. 2007 and Ahmet Kondoz, Visual media coding and transmission, (Wiley, UK), c. 2009, the disclosure of which is incorporated herein by reference.

In order to enable a motion vector to not only refer to a past frame but also refer to a future frame, video coding incorporates bidirectional frames (B frames). Bidirectional frames are compressed through a predictive algorithm derived from previous reference frames (forward prediction) or future reference frames (backward prediction). Each bidirectional frame employs at least two reference frames, either past or future ones, to greater exploit any correlation between frames (even if there is no correlation in the past frames, it is still possible that there is correlation in the future frames) and achieve better coding efficiency. Normally, bidirectional frames are not served as the references of other frames. In other words, other frames do not depend on bidirectional frames. As a result, B frames are not used for applications such as random access and bitstream switching.

Recently, coding schemes defined in the H.264 standard that use a hierarchical bidirectional frame structure have drawn attention due to their coding efficiency and flexibility. The video coding standard H.264 is described in T. Wiegand, G. Sullivan, A. Luthra, “Draft ITU-T Recommendation and Final Draft International Standard of Joint Video Specification (ITU-T Rec. H.264|ISO/IEC 14496-10 AVC)”, document JVT-G050r1, 8th meeting: Geneva, Switzerland, 23-27 May 2003, the disclosure of which is incorporated herein by reference. The schemes in this coding standard present a coding structure that uses bidirectional frames as references. For example, the current multi-view video coding standards have adopted the hierarchical bidirectional frame structure as its prediction structure. As used herein, “frame structure” can refer to the sequence of frames of different types as output from an encoder, or a bitstream incorporating such frames. A PSB frame structure is a sequence of frames incorporating at least one PSB frame. The multi-view video coding standards are described in A. Vetro, Y. Su, H. Kimata, and A. Smolic, “Joint Draft 1.0 on Multiview Video Coding,” Doc. JVT-U209, Joint Video Team, Hangzhou, China, October 2006, and A. Vetro, P. Pandit, H. Kimata, and A. Smolic, “Joint draft 9.0 on multi-view video coding,” Doc. JVT-AB204, Joint Video Team, Hannover, Germany, July 2008, the disclosure of which is incorporated herein by reference. Some software verification models for multiview coding are also described in A. Vetro, P. Pandit, H. Kimata, and A. Smolic, “Joint Multiview Video Model (JMVM) 6.0,” Doc. JVT-Y207, Joint Video Team, Shenzhen, China, October 2007, and P. Pandit, A. Vetro, and Y. Chen, “JMVM 8 software,” Doc. JVT-AA208, Joint Video Team, Geneva, CH, April. 2008, the disclosure of which is incorporated herein by reference.

The claimed invention utilizes these widely available bi-directional frames as access points for various applications, such as single view access in multi-view coding, transcoding from multi-view video coding (MVC) to advanced video coding (H.264/AVC bitstream), random access in bitstreams, bitstream switching, and error resilience. A multi-view video bitstream contains a number of bitsteams, in which each bitstream represents a view. For example, these multiple views can be video captures of a scene at various angles.

Multi-view video coding techniques and structures are further described in Y.-S. Ho and K.-J. Oh, “Overview of Multi-view Video Coding,” in Systems, Signals and Image Processing 2007 and 6th EURASIP Conference focused on Speed and Image Processing, Multimedia Communications and Services, 14th International Workshop on, 2007, pp. 5-12 and Merkle P., Smolic A., Muller K., and Weigand T., “Efficient Prediction Structures for Multi-View Video Coding”, IEEE TRANSACTIONS ON CIRCUITS AND SYSTEMS FOR VIDEO TECHNOLOGY, vol. 17, issue 11, pp 1461-1473, November 2007, the disclosure of which is incorporated herein by reference.

The claimed invention provides a new frame type to enable single view access in multi-view video. The new frame type is referred to herein as primary synchronized bidirectional frame (PSB). The primary synchronized bidirectional frame may be generated by modifying the original B frame type of the H.264/AVC standard. The modification of the original B frame may be performed by a modified B frame encoder, for example in which transform, quantization, dequantization and inverse transform processing functions are added to the standard B frame encoder. The PSB frame type may be thus generated from an incoming raw digital video signal. The PSB frame type is applicable for coding the anchor frames in the multi-view video to achieve fast view access and MVC-to-AVC transcoding. The PSB frame type is also applicable to replace some or all B frames in the H.264 bitstream with hierarchical B structure at higher levels to provide faster frame access. As used herein, “level” refers to the position of the frame in the decoding order. Higher level frames depend upon fewer frames to decode.

The claimed invention may provide a synchronized independent (SI) frame. Each SI frame is coded and decoded without reliance on other frames. Each PSB frame preferably has a corresponding SI frame for single-view access. Through generation of PSB frames, SI frames may be created. The reconstructed coefficients in the PSB frame encoder may be used as the inputs for encoding the SI frame. The SI frame may fulfill the specifications of the extended profile of the H.264/AVC standard and may be designed to be used with a SP frame in a bitstream. The SI frame may be used to reconstruct a frame that has same reconstruction as an SP frame. The SI frame is preferably encoded by: first, generating an output by transforming and quantizing the reconstructed coefficients of the SP frame or those of the PSB frame and second, encoding the output through intra prediction. When the SI frame is decoded, the quality of the SI frame is preferably equal to the quality of the corresponding SP frame or the quality of the corresponding PSB frame since the coding of the SI frame reuses the reconstructed coefficients from the SP frame or the PSB frame. The SI frame may share the same quality as the PSB frame.

The introduction into a bitstream of SP and SI frame types is described in M. Karczewicz and R. Kurceren, “A Proposal for SP-frames”, document VCEG-L27, 12th meeting, Eibsee, Germany, 9-12 Jan., 2001, the disclosure of which is incorporated herein by reference. The design of SP frame and SI frame and the use thereof in seamless switching at predictive frame between bitstreams with different bitrates are described in M. Karczewicz and R. Kurceren, “The SP-and SI-Frames Design for H.264/AVC,” IEEE TRANSACTIONS ON CIRCUITS AND SYSTEMS FOR VIDEO TECHNOLOGY, vol. 13, pp. 637-644, July 2003, the disclosure of which is incorporated herein by reference. The improvement on the coding efficiency of SP frames is described in X. Sun, S. Li, F. Wu, J. Shen, and W. Gao, “The improved SP frame coding technique for the JVT standard,” in International Conference on Image Processing 2003, pp. 297-300 vol. 2, the disclosure of which is incorporated herein by reference. The application of SP frame on drift-free switching is described in X. Sun, F. Wu, S. Li, G. Shen, and W. Gao, “Drift-Free Switching of Compressed Video Bitstreams at Predictive Frames,” IEEE TRANSACTIONS ON CIRCUITS AND SYSTEMS FOR VIDEO TECHNOLOGY, vol. 16, pp. 565-576, May 2006, the disclosure of which is incorporated herein by reference.

The claimed invention may further provide a PSB frame and a corresponding SI frame in multi-view coding. This enables MVC-to-AVC transcoding in multi-view video. A common problem in multi-view video playback is drift. A bitstream with PSB frames and corresponding SI frames reduces drift. Moreover, fewer bits are transmitted and decoded so that the processing time is reduced and lower decoder complexity is required.

The claimed invention may provide a PSB frame and a corresponding SI frame for random frame access. A problem in random access is the high cost. For example, when hierarchical B frames are employed in a H.264 bitstream, in order to access one frame, on average five frames are required to be decoded in the case when group of picture (GOP) is equal to 16. By encoding a bitstream having PSB frames, the cost for random access is reduced. For example, in terms of the number of frames to be processed. about 40% on average is saved in the random access of a H.264 bitstream with PSB frames when hierarchical B structure of GOP is equal to 16. This means about 40% of decoding time can be saved if the decoding time of each frame type is the same. During conventional playback, PSB frames are decoded, whereas SI frames are stored for random access.

The claimed invention may further provide a secondary synchronized bidirectional frame (SSB). The SSB frame is generated from one bitstream to match with the image quality of the primary synchronized bidirectional frame (PSB) in another bitstream. The matching of the image quality might be in terms of PSNR (Peak Signal to Noise Ratio). Through incorporating SSB frames and PSB frames into a bitstream, drift-free bitstream switching is achieved even though PSB frame and SSB frame are coded from two different references. For example, a mobile device may be receiving a video bitstream at a high bitrate. However, following a change in a network condition external to the mobile device, the mobile device may continue receiving the same video bitstream but at a lower bitrate. The mismatch in bitrate will lead to drifting and downgrade the movie quality. Drifting arises as some frames in a video bitstream are decoded based on previous frames and the decoding is prone to error if there is a mismatch, which can become progressively worse as any errors will accumulate The provision of PSB frame and SSB frame can avoid such a mismatch.

The claimed invention may further provide several PSB frames in place of high level B frames in the H.264 bitstream with hierarchical B frame structure to provide good error resilience in an error recovery method. If a PSB frame is affected by error, it is recoverable from its corresponding SI frame. This is because each PSB frame and its SI frame have substantially the same quality, it is possible to recover the corresponding PSB frame by providing the SI frame for decoding upon deciding that a frame is affected by error. Decoding of the PSB frames requires reference frames, but no reference frames are required for decoding of the SI frames. An SI frame is decodable by the decoder into a PSB frame without reference to other frames.

The claimed invention may provide apparatus to generate each or any of the above-mentioned frame types, or generate a data structure such as a bitstream incorporating one or more of the above-mentioned frame types. The generation may be via encoding. The claimed invention may also provide apparatus to decode the bitstream. The claimed invention may be implemented by circuitry. As used herein, “circuitry” refers without limitation to hardware implementations, combinations of hardware and software, and to circuits that operate with software irrespective of the physical presence of the software. Software includes firmware. Hardware includes processors and memory, in singular and plural form, whether combined in an integrated circuit or otherwise. The claimed invention may be implemented as a decoder chip, as an encoder chip or in apparatus incorporating such chip or chips.

The claimed invention may be provided as a computer program product, for example, on a computer readable medium, with computer instructions to implement all or a part of the method as disclosed herein.

The claimed invention may provide a system having encoding and decoding apparatus for encoding and decoding one or more of the frame types as disclosed herein.

The claimed invention may provide a data structure such as a bitstream incorporating one or more of the above mentioned frame types. The bitstream may be stored on a physical data storage medium or transmitted as a signal.

### BRIEF DESCRIPTION OF THE DRAWINGS

Aspects and embodiments of the claimed invention will be described hereinafter in more details with reference to the following drawings, in which:

FIG. 1A shows a flowchart of a digital video processing method to provide a video bitstream with a PSB frame structure for various applications.

FIG. 1B shows an illustration of single view access in multi-view video.

FIG. 2A shows an illustration of MVC-to-AVC transcoding in multi-view video.

FIG. 2B shows an illustration of random access in the hierarchical B frame structure.

FIG. 3 shows a block diagram for a PSB frame encoder.

FIG. 4 shows a block diagram for a PSB frame decoder.

FIG. 5 shows a block diagram for a SSB frame encoder.

FIG. 6 shows a block diagram of a SSB frame decoder.

FIG. 7 shows a block diagram of an SI frame encoder.

FIG. 8 shows a block diagram of an SI frame decoder.

FIG. 9 shows an embodiment of a PSB frame encoder.

FIG. 10 shows an embodiment of a PSB frame decoder.

### DETAILED DESCRIPTION OF THE INVENTION

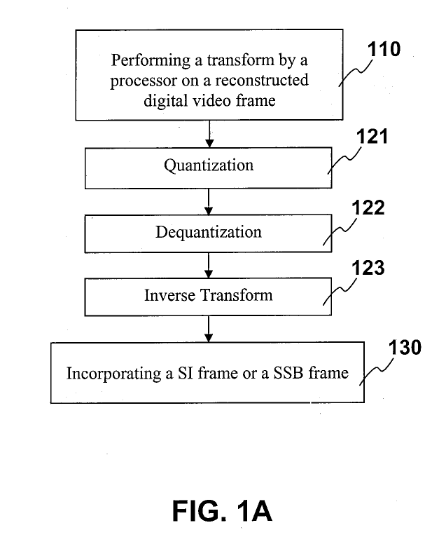

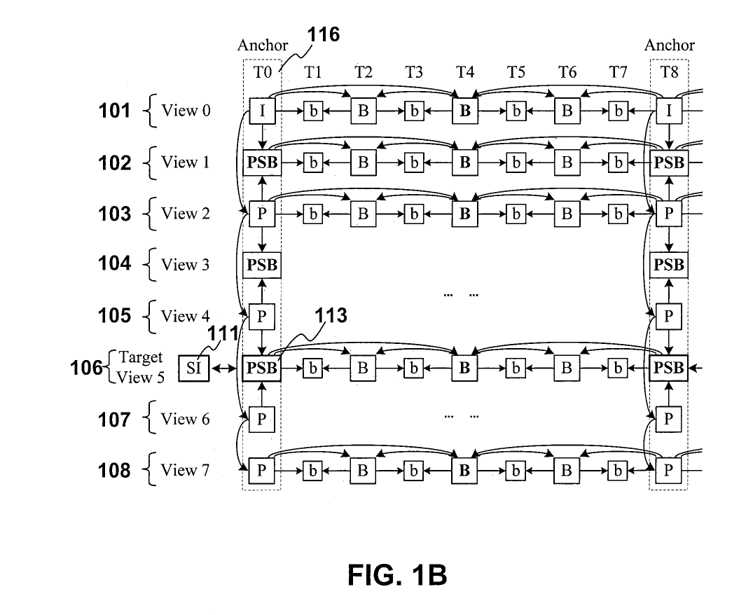

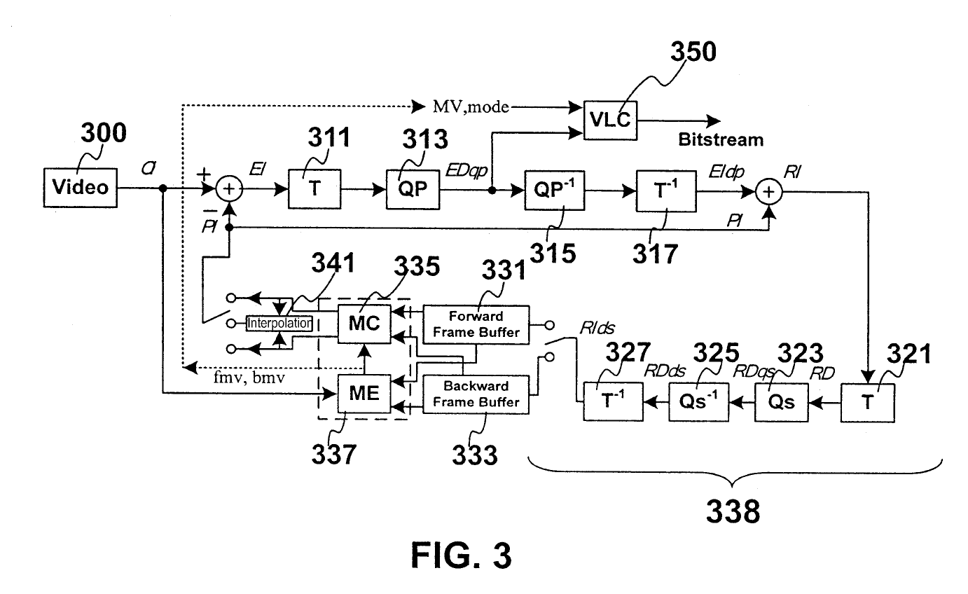

FIG. 1A shows a flowchart of a digital video processing method to provide a video bitstream with a PSB frame structure for various applications. FIG. 1A also shows an optional final step 130 of incorporating a SI frame or SSB frame The digital video processing method is applicable to encoding a digital video at an encoder as well as decoding a digital video at a decoder. At an encoder (as shown for example in FIG. 3), the current digital video frame in a digital video will be processed by a processor with an input of one or more previously reconstructed digital video frames. The reconstructed frames, for example, represents at least two references, one from the preceding frames and the other from the future frames. The previously reconstructed digital video frames include frames for forward prediction and backward prediction. The previously reconstructed digital video frames are stored in one or more buffers. Motion compensation is performed on the previously reconstructed digital video frames before comparing a signal representing the previously reconstructed digital video frames with the current digital video frame to obtain the difference between them. The difference is transformed, quantized, dequantized and inversely transformed by the processor to give an inverse transform output. The inverse transform output is added to a signal representing the previously reconstructed digital video frames to output a newly reconstructed digital video frame. Therefore, a reconstructed digital video frame is obtained through a motion-compensated prediction. Then the processor performs a transform 110, a quantization 121, a dequantization 122 and an inverse transform 123 on the reconstructed digital video frame to convert a digital video bitstream into a digital video bitstream with a PSB frame structure. This transform 110, quantization 121 and inverse process (122, 123) is performed on the reconstructed signal to create a quantized transform domain signal (RDqs, FIG. 3) of the reconstructed image in the process of generating bitstream with one or more PSB frames. The quantized transform domain signal (RDqs) is used to encode the corresponding SI frame or the corresponding SSB frame, which has the same quality as the PSB frame. As long as the same quantization block has been included for the bitstream with the PSB frame and the corresponding SI frame or the corresponding SSB frame, the reconstruction quality will be the same between the PSB frame with the SI frame and the PSB frame with the SSB frame.

At a decoder, an input data bitstream is decoded by variable length decoding. The decoding result is dequantized and inversely transformed to give an inverse transform output. The inversely transform output is added to the previously reconstructed digital video frames which are motion compensated to output a reconstructed digital video frame. The processor performs a transform 110, a quantization 121, a dequantization 122 and an inverse transform 123 on the reconstructed digital video frame to convert a digital video bitstream into a digital video bitstream with a PSB frame structure.

When the digital video processing method is applied to a multi-view video, a single view video bitstream is retrievable by the processor in the decoder by incorporating a SI frame into the multi-view video bitstream. The multi-view video has a MVC (Multi-view Video Coding) format. The single-view video has a H.264/AVC (Advanced Video Coding) format. To enable the conversion from a multi-view standard to a H.264/AVC standard, the syntax of the multi-view standard is modified by the processor into a single-view standard. For example, syntax of the MVC standard is modified into syntax of the H.264/AVC standard by the processor so that a decoder of an H.264/AVC video is capable of decoding the single-view video bitstream retrieved from the claimed digital video processing method. Furthermore, in the MVC-to-AVC transcoding, the anchor frames are decoded in the order of I-P-P-PSB and the signal obtained from decoding the PSB frame is used to decode the corresponding SI frame. The AVC compatible bitstream is composed of the SI frame and the original non-anchor B frames from the MVC bitstream. The access point bitstream refers to the bitstream containing the SI frame. In the view access or the random access applications, the SI frame needs to be encoded and stored as an additional access point bitstream, i.e. a bitstream with all SI frames. An approach that transcodes one single view of MVC bitstream into an independent H.264 bitstream by transcoding an anchor frame into I frames is described in Y. Chen, Y.-K. Wang, and M. M. Hannuksela, “Support of lightweight MVC to AVC transcoding,” in Joint Video Team (JVT) of ISO/IEC MPEG & ITU-T VCEG (JVT-AA036) Geneva, CH, 2008, the disclosure of which is incorporated herein by reference.

When the digital video processing method is applied to a digital video bitstream with a hierarchical B frame structure, for example, an H.264 digital video bitstream, the use of the PSB frame and the SI frame allows random access of frames in the digital video bitstream with the hierarchical B frame structure. In addition, when an error happens to a digital video bitstream, the desired frame is easily retrieved by the use of the PSB frame and the SI frame. The error resilience of a digital video bitstream is thus enhanced because the retrieval of the desired frame can be achieved independent of the erroneous frame in the digital video bitstream. No reference frame, which may also be corrupted, is required by the SI frame.

Furthermore, the digital video processing method is applicable in bitstream switching, for example, switching the digital bitstream with another digital video bitstream having a lower data rate. During bitstream switching, a PSB frame is used with an SSB frame intended for a decoder of another video bitstream to obtain error-free reconstructed frames thus achieving drift-free bitstream switching.

The insertion of PSB frames depends on application. In an illustrative embodiment, the PSB frames are used in anchor frames in multi-view video as shown in FIG. 1B for view accessing and MVC-to-AVC transcoding. The multi-view coding encodes eight views and also shows the types of frames at time increments T1, T2, T3 . . . between anchor frames at T0 and T8. I, B, SI and PSB frame types are shown; b frames are a type of B frame. For simplicity, not all of the frames in a bitstream are shown where the sequence is the same as one of the preceding bitstream. The arrows between frame types indicate reference relationships between the frames. In this embodiment, the I frame in View 0 101 is independently retrievable. The PSB frame in View 1 is retrievable by using the I frame in View 0 and the PSB frame in View 2 as the reference frames. The P frame in View 2 is retrievable by using the I frame in View 0 as the reference frame. The PSB frame in View 3 is retrievable by using the P frame in View 2 and the P frame in View 4 as the reference frames. The P frame in View 4 is retrievable by using the P frame in View 2 as the reference frame. The PSB frame in View 5 is retrievable by using the P frame in View 4 and the P frame in View 6 as the reference frames, or is retrievable by using the SI frame 111. The P frame in View 6 is retrievable by using the P frame in View 4 as the reference frame. The P frame in View 7 is retrievable by using the P frame in View 6 as the reference frame. In order to access one single view such as View 5 106, View 5 106 is encoded in a way that a PSB frame 113 is provided. Together with other frames in View 0 101, View 1 102, View 2 103, View 3 104, View 4 105, View 6 107, View 7 108, the PSB frame 113 becomes part of an anchor bitstream 116. Using a SI frame 111 which corresponds to the PSB frame 113 provides an access point to view 5 106.

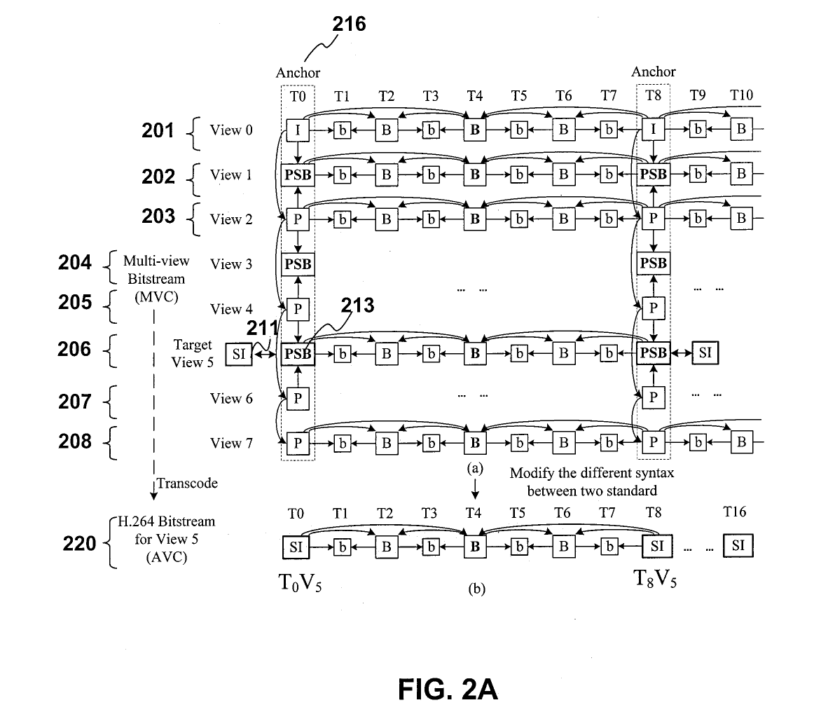

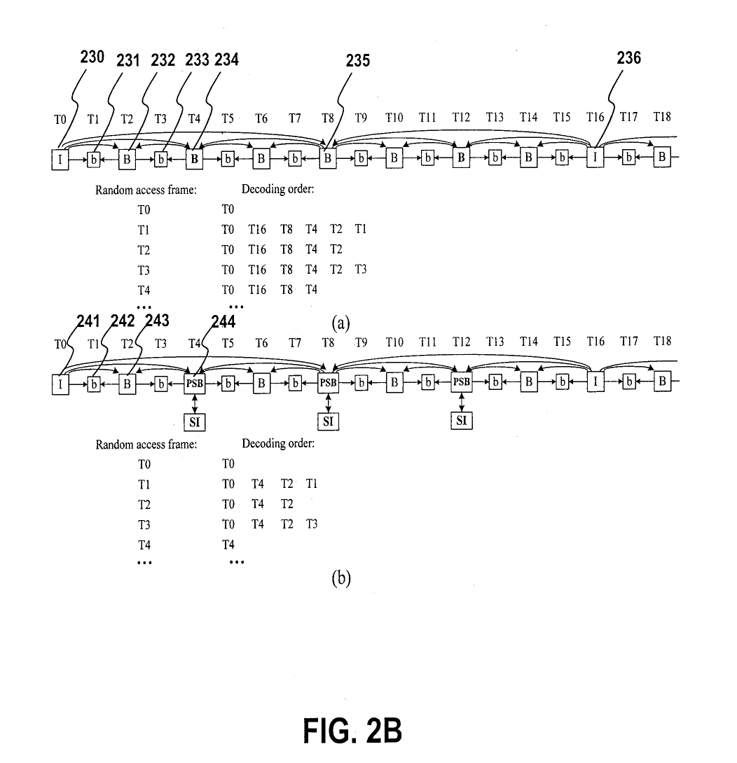

FIG. 2A shows an illustration of MVC-to-AVC transcoding in multi-view video. In part (a) of FIG. 2A, a multi-view video bitstream is shown having frame types of I frames, B frames, b frames, P frames, PSB frames and I frames. Bitstream 201 provides a bitstream of View 0. Bitstream 202 provides a bitstream of View 1. Bitstream 203 provides a bitstream of View 3. Bitstream 204 provides a bitstream of View 4. Bitstream 205 provides a bitstream of View 5. Bitstream 206 provides a bitstream of View 6. Bitstream 207 provides a bitstream of View 7. However, due to the dependency between the anchor frames of different bitstreams for Views (as shown by the arrows: those arrows with their heads pointing away from the frame mean the frame is the reference frame of other frames which the arrows point to, as for FIG. 1A), only bitstream 201 of View 0 can be decoded independently. That is, when bitstreams from 202 to 208 are desired, frames from other bitstreams 201 to 208 are also required. When the H.264/AVC decoder is only available in a client platform (not shown), the multi-view video bitstream is transcoded to an independent H.264 bitstream for the desired view. Adopting PSB frames and SI frames in MVC provides an effective transcoding from MVC to AVC, for example, when the client platform uses the H.264 decoder to decode View 5 206. Furthermore, the SI frame 211 is used in the new bitstream together with the B frames from View 5 206. By further modifying the difference between MVC and AVC bitstream syntax through a process known as video transcoding, an independent H.264/AVC bitstream 220 is produced as shown in part (b) of FIG. 2A. Video transcoding is described in Al Bovik, Handbook of image and video processing, (Elsevier/Academic Press, Massachusetts), c. 2005 and Ashraf M. A. Ahmad, et al, Multimedia Transcoding in Mobile and Wireless Networks, (Idea Group Inc (IGI), PA), c. 2008, the disclosure of which is incorporated herein by reference.

In another embodiment (not shown) for insertion of the PSB frame, PSB frames are put in higher levels of the hierarchical B structure. The coding efficiency of the H.264 bitstreams is taken into consideration for replacing the position normally occupied by B frames by the PSB frames. In a further embodiment (not shown), the PSB frames generated take the place of all the B frames but the coding efficiency will be lower. The coding efficiency is optimized if not all the B frames are replaced by the PSB frames, for example, the PSB frames are inserted at the first and second levels of the hierarchical B structure to attain a good tradeoff between providing random access and coding efficiency.

FIG. 2B shows a comparative illustration of random access in a hierarchical B frame structure with and without PSB frames, together with decoding orders of frames for randomly accessing a frame in a View. A conventional hierarchical B structure is shown in FIG. 2B (a), in which there are several levels of B frames. The higher the level the fewer frames needed to be accessed to decode that frame. The first level is T8 (the highest level in FIG. 2B), which refers to T0 and T16. The second level is T4 and T12. The third level is T2, T6, T10 and T14. By using PSB frames at T8, T4 and T12 to replace B frames in the conventional hierarchical B structure, the proposed decoding structure is improved, as shown in FIG. 2B (b).

As indicated in part (a) of FIG. 2B, in the conventional H.264 bitstream with the hierarchical B frame structure, randomly accessing one frame in the bitstream requires many reference frames to be transmitted and decoded. In order to access the frame at time T1 231, reference frames including I frame 230 at time T0, B frame 236 at time T16, B frame 235 at time T8, B frame 234 at time T4 and B frame 232 at time T2 together with B frame 231 at time T1 itself are transmitted and decoded. By replacing some B frames at a higher level of the hierarchical B frame structure with PSB frames as shown in part (b) of FIG. 2B, the random access cost can be reduced. For example, accessing the reference frame at T1 242 requires decoding 4 frames including I frame 241 at time T0, PSB frame 244 at time T4 (SI frame), B frame 243 at time T2 and B frame 242 at time T1 in the hierarchical B frame structure with PSB frames, compared to 6 frames in the conventional hierarchical B frame structure bitstream. Since B frames are encoded with reference to other frames, in order to decode one B frame, the reference frames of that B frame are required to be obtained first.

As shown in FIG. 2B (b), for example, accessing the frame 242 at T1 requires decoding the two reference frames thereof first, including: I frame 241 at time T0 and B frame 243 at time T2.

In order to decode the B frame 243 at time T2, the two reference frames of the B frame are required to be decoded, including: I frame 241 at time T0 and frame 244 at time T4 (SI frame). If PSB frame is used at T4, we can decode the corresponding SI frame instead of PSB frame. Therefore, totally, frames at time T0, T4, T2 and T1 are decoded for accessing the frame 242 at T1.

On the contrary, as shown in FIG. 2B (a), B frame 234 is used at T4. As a result, we need to decode its reference frames: frames at time T0 and T8 first. Again, since the frame at time T8 is a B frame, we need to decode the frames at time T0 and T16 first. In that case, frames at time T0, T16, T8, T4, T2 and T1 are decoded in the decoding order.

FIG. 3 shows a block diagram for a PSB frame encoder. The PSB frame encoder encodes a video 300 with PSB frames embedded therein. It includes a forward frame buffer 331 to hold frames for forward prediction and a backward frame buffer 333 to hold frames for backward prediction. In an exemplary embodiment, the PSB frame encoder is implemented by at least one processor; and at least one memory including computer program code; the at least one memory and the computer program code configured to, with the at least one processor, cause the apparatus to perform the PSB frame encoder's functions. There is at least one memory to store the data and act as buffers. The digital video signal outputs of both the forward frame buffer 331 and the backward frame buffer 333 are used for motion estimation in a motion estimator (abbreviated as ME in the drawings) 337 and for motion compensation in a motion compensator (abbreviated as MC in the drawings) 335. The video 300 is provided to the motion estimator 337 to perform motion estimation. The digital video signal output of the motion estimator 337 is provided to the motion compensator 335 to perform motion compensation. The interpolator 341 uses the digital video signal output of the motion compensator 335 to perform interpolation and provide an interpolated digital video signal output.

The arrangement of the forward frame buffer 331 and the backward frame buffer 333 is specifically for producing B frames. Consequently, when compared with P frames, B frames have more frames to reference to as there are more motion estimation directions such as forward, backward and bidirectional.

The interpolated digital video signal output and the digital video signal output of the motion compensator 335 are a predicted digital video signal PI. The predicted digital video signal PI is compared with the video 300 which is the source digital video signal OI. By subtracting the predicted digital video signal from the source digital video signal OI, an error digital video signal EI is generated.

EI=OI−PI

The error digital video signal EI is then transformed (referred to as T in the drawings) by a first transformer 311 and quantized (referred to as QP in the drawings) with a step size qp by a first quantizer 313. Therefore, the comparison is performed in pixel domain rather than frequency domain.

The digital video signal output of the first quantizer 313 is denoted as EDqp. The digital video signal output EDqp is used for variable length coding by a variable length coder (referred to as VLC in the drawings) 350. The variable length coder 350 encodes the quantized digital video signal output of the first quantizer 313 together with a plurality of parameters such as motion vectors (referred to as fmv, bmv and collectively as my in the drawings) and modes which are computed according to the motion estimation by the motion estimator 337. The digital video signal output of the variable length coder 350 is transmitted over a channel as a bitstream.

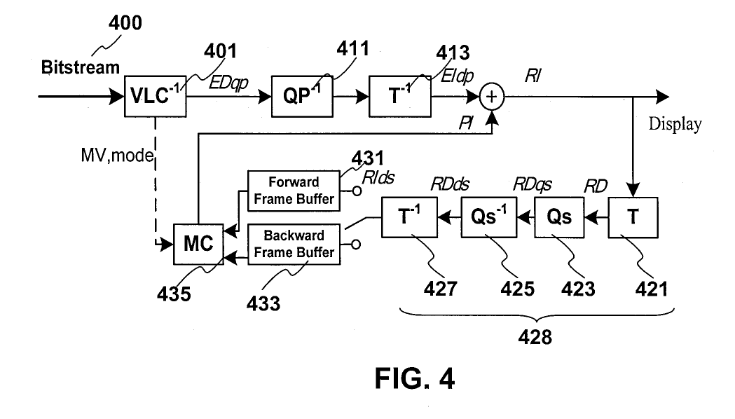

The quantized digital video signal output of the first quantizer 313 is also provided to a dequantizer 315 for dequantization with a step size qp. After dequantization, the digital video signal output of the first dequantizer 315 is inverse transformed by a first inverse transformer 317. Inverse processes are indicated in the drawings by the superscript⁻¹. After the inverse transform, the first inverse transformer 317 output a residual digital video signal EIdp. The residual digital video signal EIdp is in pixel domain before it is combined with the predicted digital video signal PI to generate a reconstructed frame RI in the same way as in a decoder (FIG. 4). The reconstructed frame RI is transformed by a second transformer 321 to output a digital video signal RD. The digital video signal RD is quantized by a second quantizer 323 with a step size qs to output a digital video signal RDqs. The digital video signal RDqs is dequantized by a second dequantizer 325 with a step size qs to output a digital video signal RDds. The digital video signal RDds is inverse transformed by a second inverse transformer 327 to output a digital video signal Rids.

This second set 338 of transform, quantization and the corresponding inverse processes by the second transformer 321, the second quantizer 323, the second dequantizer 325 and the second inverse transformer 327 is provided for preparation of PSB frame. If only preparing B frames, this second set of transform, quantization and the corresponding inverse processes is not used. The difference between the generation of the PSB frame and the B frame is the second set 338. With this second set 338, the frames are encoded as PSB frames instead of B frames in the original structure as shown in FIG. 2B, and in other words, the PSB frames take the place of the B frames in the bitstream. Deciding which B frames are replaced by the PSB frames depends on the application. For example, in random access applications, only higher levels of the hierarchical B frames, as shown in FIG. 2B (b) are replaced by PSB frames. In other embodiments, other patterns of replacement are preferred.

The digital video signal RDds output from this second set 338 of transform, quantization and the corresponding inverse processes is used as the input for the forward frame buffer 331 and the backward frame buffer 333 respectively. Normally, when producing B frames the inputs to these buffers are the reconstructed frame RI.

FIG. 4 shows a block diagram for a PSB frame decoder. It includes a forward frame buffer 431 to hold frames for forward prediction and a backward frame buffer 433 to hold frames for backward prediction. The digital video signal outputs of both the forward frame buffer 431 and the backward frame buffer 433 are used for motion compensation in a motion compensator 435. The bitstream 400 is provided to the motion estimator 337 to perform motion estimation. In an exemplary embodiment, the PSB frame decoder is implemented by at least one processor; and at least one memory including computer program code; the at least one memory and the computer program code configured to, with the at least one processor, cause the apparatus to perform the PSB frame decoder's functions. There is at least one memory to store the data and act as buffers.

The bitstream 400 is decoded by a variable length decoder 401. After the variable length decoding by the variable length decoder 401, parameters such as motion vectors and modes are provided to the motion compensator 435 from the variable length decoder 401, while the decoded digital video signal EDqp is provided to a first dequantizer 411. The first dequantizer 411 applies dequantization with a step size qp to the decoded digital video signal EDqp. The digital video signal output of the dequantizer 411 is inverse transformed by the first inverse transformer 413. The inverse transformer 413 gives a digital video signal output EIdp after performing the inverse transform.

The digital video signal output of the motion compensator 435 is a predicted digital video signal PI. The predicted digital video signal PI is added to the digital video signal output EIdp of the first inverse transformer 413 in the pixel domain to generate a residual digital video signal RI:

RI=PI+EIdp

The residual signal RI is output to display, and a copy is also taken and transformed by a second transformer 421 to output a digital video signal RD. The digital video signal RD from the second transformer 421 is quantized by a second quantizer 423 with a step size of qs to output a digital video signal RDqs. The digital video signal RDqs from the second quantizer 423 is dequantized by a second dequantizer 425 with a step size of qs to output a digital video signal RDds. The digital video signal RDds is inverse transformed by a second inverse transformer 427 to output a digital video signal Rids.

The digital video signal Rids output from set 428 of transform, quantization and the corresponding inverse processes is used as the input for the forward frame buffer 431 and the backward frame buffer 433 respectively.

This set 428 of transform, quantization and the corresponding inverse processes by the second transformer 421, the second quantizer 423, the second dequantizer 425 and the second inverse transformer 427 is provided for a bitstream with PSB frames. While for decoding a bitstream with B frames only, this set 428 of transform, quantization and the corresponding inverse processes does not occur. Instead, the input to the buffers is the residual signal RI.

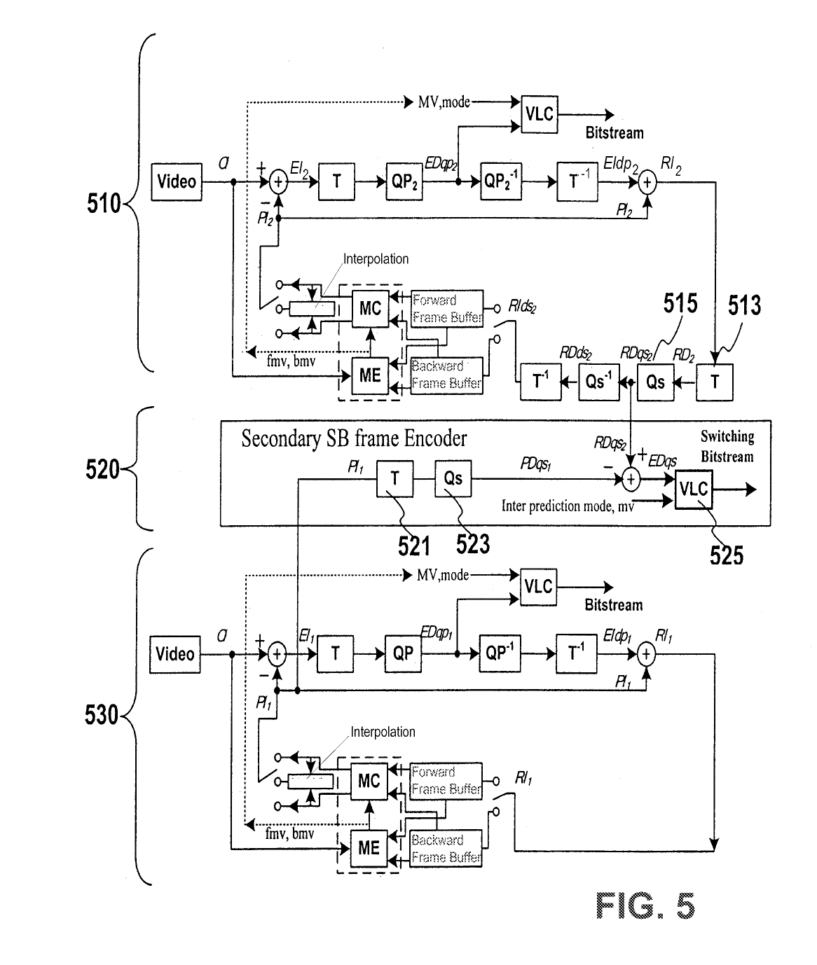

FIG. 5 shows a block diagram for a SSB frame encoder 520. The input of the SSB encoder 520 is provided by a B frame encoder 530 which can also provides P frames and be a P frame encoder. The digital video signal output from motion compensation by the B frame encoder 530 is a predicted digital video signal PI₁. The predicted digital video signal PI₁ is input to the SSB encoder 520. The predicted digital video signal PI₁ can be either interpolated or not interpolated. The SSB encoder 520 uses a transformer 521 to transform the predicted digital video signal PI₁ by the B frame encoder 530 to generate a transformed digital video signal. The transformed digital video signal is quantized by a quantizer 523 with a step size qs and provides a quantized digital video signal PDqs₁. In an exemplary embodiment, the SSB frame encoder 520 is implemented by at least one processor; and at least one memory including computer program code; the at least one memory and the computer program code configured to, with the at least one processor, cause the apparatus to perform the SSB frame encoder's 520 functions. There is at least one memory to store the data and act as buffers.

The reconstructed frame RI₂ generated by a PSB frame encoder 510 is transformed by a second transformer 513 into a digital video signal RD₂ as described above with reference to FIG. 3. The digital video signal RD₂ is quantized with a step size qs by a second quantizer 515 to output a digital video signal RDqs₂. The digital video signal RDqs₂ is compared with the quantized digital video signal PDqs₁ to give a difference digital video signal EDqs:

EDqs=RDqs₂−PDqs₁

The difference digital video signal EDqs is provided to a variable length coder 525 of the SSB frame encoder together with parameters such as motion vectors and inter prediction mode to generate a switching bitstream. Using the switching bitstream, drift-free switching is achieved by decoding the switching bitstream at the decoder side.

As illustrated in FIG. 5, the SSB frame is constructed by subtracting PDqs₁ from RDqs₂, both of them are in the quantized transform domain as shown in FIG. 5. In the SSB frame encoder 520 as shown in FIG. 5, EDqs=RDqs₂−PDqs₁ which gives the SSB frame.

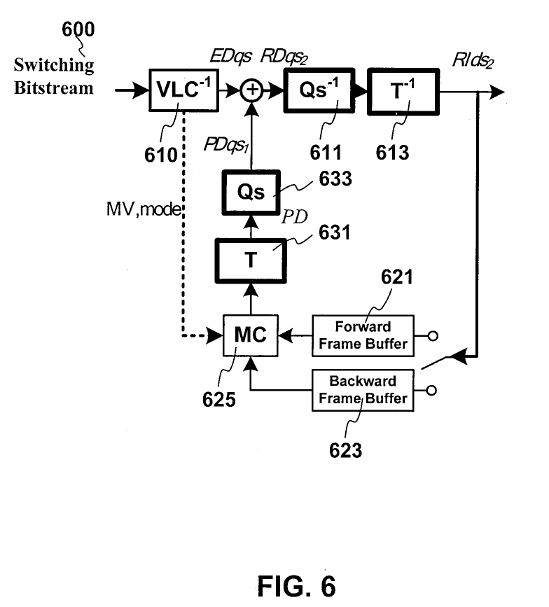

FIG. 6 shows a block diagram of a SSB frame decoder. The switching bitstream 600 is processed by a variable length decoder 610. The variable length decoder 610 uses the switching bitstream 600 to provide motion vectors and modes to a motion compensator 625. After variable length decoding, the variable length decoder 610 outputs an error digital video signal EDqs.

With the motion vectors and modes information, the motion compensator 625 performs motion compensation using the data from a forward frame buffer 621 and a backward frame buffer 623. The digital video signal output of the motion compensator 625 is transformed by a transformer 631 to give a predicted digital video signal PD. The digital video signal PD is quantized by a quantizer 633 with a step size of qs to give a digital video signal output PDqs₁.

The digital video signal output PDqs₁ of the quantizer 633 is added to the error digital video signal ED from the variable length decoder 610 to give a combined digital video signal RDqs₂:

RDqs₂=EDqs+PDqs₁

The combined digital video signal RDqs₂ is dequantized by a dequantizer 611 with a step size of qs and subsequently inverse transformed by an inverse transformer 613. The digital video signal output of the inverse transformer 613 is used as a PSB frame in a PSB frame bitstream for switching to that PSB frame bitstream. The digital video signal RIds₂ output from the inverse transformer 613 is also provided to the forward frame buffer 621 and the backward frame buffer 623. This is to ensure that there is no mismatch in the frame buffers during bitstream switching.

As illustrated by FIG. 6, the PDqs₁ is reconstructed from the PD frame and the PD frame is the same as the PD frame used in the SSB frame encoder 520 as shown in FIG. 5. After obtaining RDqs₂ from RDqs₂=EDqs+PDqs₁, the RIds₂ is obtained by dequantization and inverse transform RIds₂=T⁻¹(Q⁻¹(RDqs₂)). The RIds₂ as obtained is substantially the same as RIds₂ which is obtained from the SSB frame encoder 520 as shown in FIG. 5.

In an exemplary embodiment, the SSB frame decoder is implemented by at least one processor; and at least one memory including computer program code; the at least one memory and the computer program code configured to, with the at least one processor, cause the apparatus to perform the SSB frame decoder's functions. There is at least one memory to store the data and act as buffers.

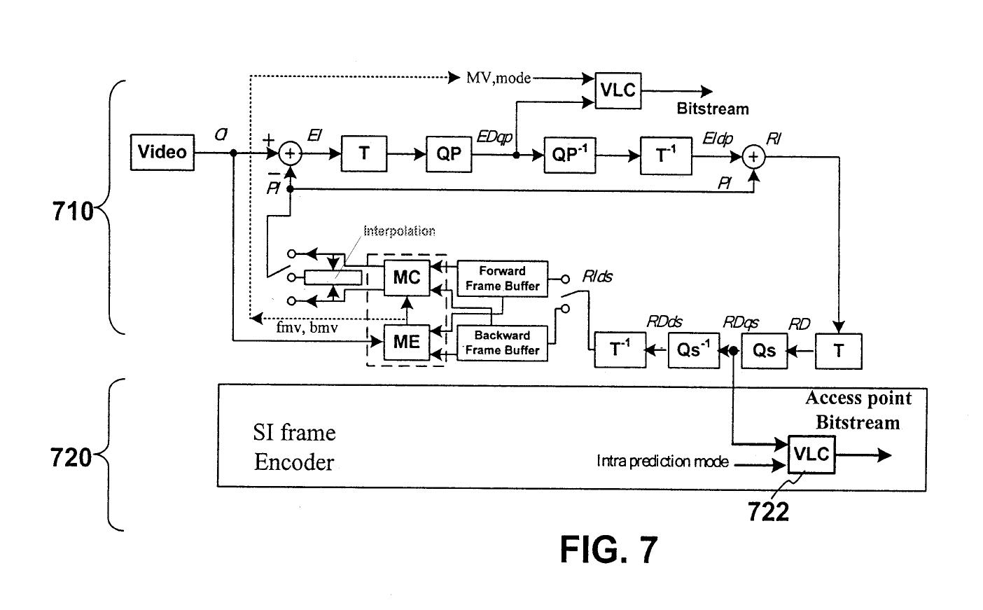

FIG. 7 shows a block diagram of an SI frame encoder 720. The SI frame encoder 720 includes a variable length coder 722. The variable length coder 722 has two inputs. One input is provided from a PSB frame encoder 710. The PSB frame encoder transforms its regenerated video by a second transformer and subsequently quantizes the regenerated video in the transformed domain by a second quantizer with a step size qs. The transformed and quantized regenerated video RDqs is input to the variable length coder 722 along with another input of intra prediction mode to generate an access point bitstream.

In an exemplary embodiment, the SI frame encoder 720 is implemented by at least one processor; and at least one memory including computer program code; the at least one memory and the computer program code configured to, with the at least one processor, cause the apparatus to perform the SI frame encoder's 720 functions. There is at least one memory to store the data and act as buffers.

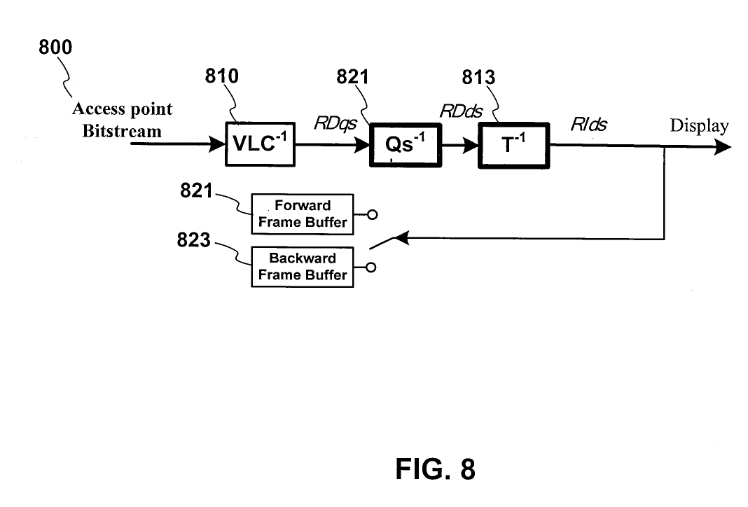

FIG. 8 shows a block diagram of an SI frame decoder. The variable length decoder 810 performs variable length decoding on the access point bitstream 800. The digital video signal output of the variable length decoder 810 is dequantized by a dequantizer 821 with a step size of qs and is subsequently inverse transformed by an inverse transformer 813 to provide a video output for display. The video output is also provided to a forward frame buffer 821 and a backward frame buffer 823 respectively.

The PSB frame encoder 711 in FIG. 7 is substantially the same as the PSB frame encoder as shown in FIG. 3. As illustrated in FIG. 4 and the corresponding description thereof, after decoding the PSB frame encoded in FIG. 3, the decoded signal of the PSB frame is equal to RIds=T⁻¹[Q⁻¹(RDqs)], where Q⁻¹ and T⁻¹ represents dequantization and inverse transform respectively. Similarly, as illustrated in FIG. 8 and the corresponding description thereof, by decoding the SI frame encoded in FIG. 7, the decoded signal of the SI frame is also equal to RIds=T⁻¹[Q⁻¹(RDqs)]. This guarantees exactly the same quality between the PSB frame and the corresponding SI frame.

In an exemplary embodiment, the SI frame decoder is implemented by at least one processor; and at least one memory including computer program code; the at least one memory and the computer program code configured to, with the at least one processor, cause the apparatus to perform the SI frame decoder's functions. There is at least one memory to store the data and act as buffers.

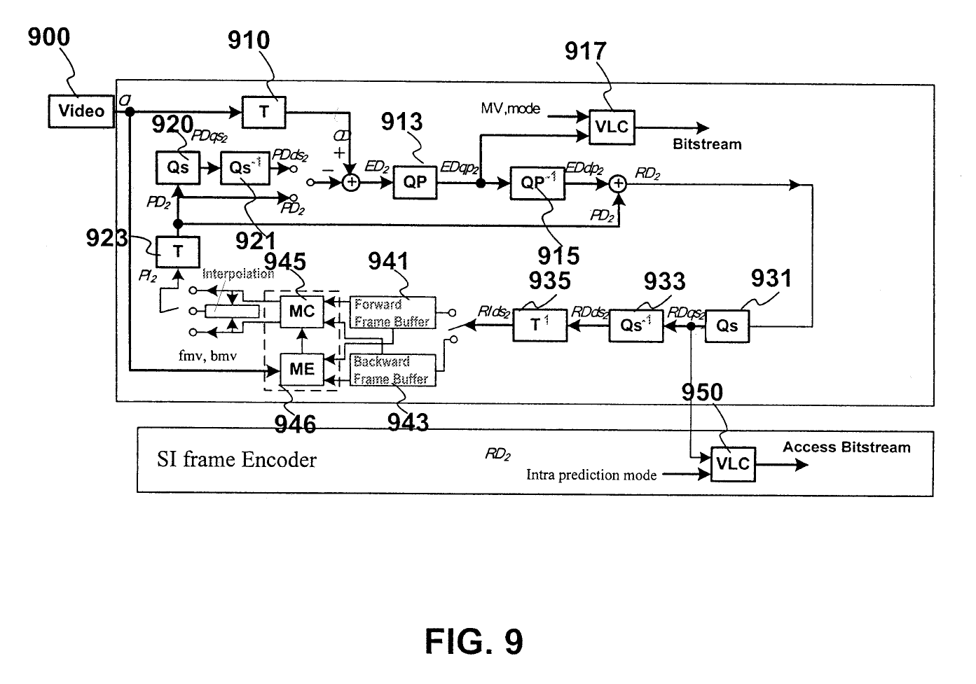

FIG. 9 shows an embodiment of a PSB frame encoder with access provided by an SI encoder. In this embodiment, a SP frame encoder is adapted to be a PSB frame encoder. The video 900 is denoted as a source digital video signal OI. The source digital video signal OI is transformed by a first transformer 910. The first transformer 910 gives a digital video signal output OD. A predicted digital video signal PI₂ is generated by switching between various digital video signal outputs of a motion compensator 945. The various digital video signal outputs of the motion compensator 945 include a digital video signal with interpolation and a digital video signal without interpolation. For forward prediction, the frames are obtained from the forward frame buffer 941. For backward prediction, the frames are obtained from the backward frame buffer 943. A motion estimator 946 carries out motion estimation by obtaining frames from either the forward frame buffer 941 or the backward frame buffer 943. The motion estimator 946 gets a forward motion vector and a backward motion vector from the source digital video signal OI. Using the digital video signal output from the motion estimator, the motion compensator 945 performs motion compensation with the frames from the forward frame buffer 941 or the backward frame buffer 943. The digital video signal output of the motion compensator 945 is provided as the predicted digital video signal PI₂ with or without interpolation. The predicted digital video signal PI₂ is transformed by a second transformer 923 to provide a digital video signal PD₂. The digital video signal PD₂ is quantized by a first quantizer 920 with a stepsize qs to provide a digital video signal PDqs₂. The digital video signal PDqs₂ is dequantized by a dequantizer 921 with a step size of qs to provide a digital video signal PDds₂. There is switching which switches between the digital video signal PDds₂ and the digital video signal PD₂. When the switching switches to the digital video signal PDds₂, the digital video signal PDds₂ is subtracted from the digital video signal output OD by the first transformer 910 to provide a digital video signal ED₂:

ED₂=OD−PDds₂

When the switching switches to the digital video signal PD₂, the digital video signal PD₂ is subtracted from the digital video signal OD by the first transformer 910, then the digital video signal ED₂ becomes:

ED₂=OD−PD₂

The digital video signal ED₂ is quantized by a second quantizer 913 with a stepsize qp to provide a digital video signal EDqp₂. The digital video signal EDqp₂ is coded by a variable length coder 917 with motion vectors MV and modes to provide a digital video signal output bitstream. The digital video signal EDqp₂ is dequantized by a dequantizer 915 with a step size of qp to provide a digital video signal EDdp₂. The digital video signal EDdp₂ is added to the digital video signal PD₂ to give a reconstructed digital video signal RD₂:

RD₂=PD₂+EDdp₂

The reconstructed digital video signal RD₂ is quantized by a third quantizer 931 with a stepsize qs to give a digital video signal RDqs₂. The digital video signal RDqs₂ is dequantized by a third dequantizer 933 with a step size of qs to give a digital video signal RDds₂. The digital video signal RDds₂ is inverse transformed by a first inverse transformer 935 to give a digital video signal RIds₂. The digital video signal RIds₂ is provided to either a forward frame buffer 941 or a backward frame buffer 943 as appropriate. The buffer management for the forward frame buffer 941 and the backward frame buffer 943 is performed before encoding. For example, as shown in FIG. 2B (b), after the PSB frame at time T8 is decoded, the decoded PSB frame is stored in a decodable picture buffer, which contains memory space for one or more frames. When frames at time T4 are being encoded, the decoded PSB frame at time T8 in the decodable picture buffer will be shifted to the backward frame buffer 943. When frames at T12 are being encoded, the decoded PSB frame at time T8 in the decodable picture buffer will be shifted to the forward frame buffer 941. Buffer management for video are also described in Jack, Keith, Video demystified: a handbook for the digital engineer, (Newnes/Elsevier, Boston), c.2007, the disclosure of which is incorporated herein by reference.

An SI frame encoder is provided to generate an access bitstream, and performs variable length coding on the digital video signal RDqs₂ from the third quantizer 931, together with the intra prediction mode as inputs. The variable length coding is done by a variable length coder 950.

In an exemplary embodiment, the PSB frame encoder and the SI frame encoder as shown in FIG. 9 are implemented by at least one processor; and at least one memory including computer program code; the at least one memory and the computer program code configured to, with the at least one processor, cause the apparatus to perform the functions of the PSB frame encoder and the SI frame encoder. There is at least one memory to store the data and act as buffers.

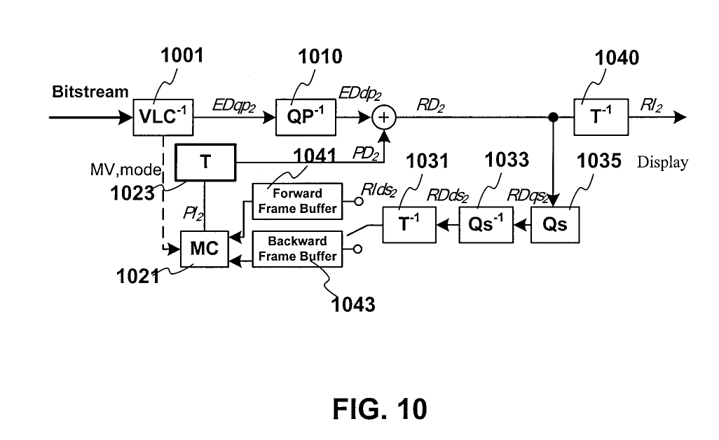

FIG. 10 shows an embodiment of a PSB frame decoder. In this embodiment, a SP frame decoder is adapted to be a PSB frame decoder. The encoded digital video bitstream of the PSB frame is decoded by variable length decoder 1001. The variable length decoder 1001 output a digital video signal EDqp₂. The digital video signal EDqp₂ is dequantized by a dequantizer 1010 with a step size of qp to output a digital video signal EDdp₂. The variable length decoder 1001 also provides motion vectors and modes to a motion compensator 1021 for performing motion compensation. The motion compensator computes a predicted digital video signal PI₂. The predicted digital video signal PI₂ is transformed by a transformer 1023 for digital video signal transform. After the digital video signal transform, the transformer 1023 output a digital video signal PD₂. The digital video signal PD₂ is added to the digital video signal EDdp₂ from the dequantizer 1010 to provide a digital video signal RD₂:

RD₂=EDdp₂+PD₂

A first inverse transformer 1040 performs inverse transform on the digital video signal RD₂ and outputs a reconstructed frame RI₂ as a video for display. The digital video signal RD₂ is quantized by a quantizer 1035 with a step size qs to output a digital video signal RDqs₂. The digital video signal RDqs₂ is dequantized by a dequantizer 1033 with a step size of qs to output a digital video signal RDds₂. The digital video signal RDds₂ is inverse transformed by a second inverse transformer 1031 to output a digital video signal RIds₂. The digital video signal RIds₂ is provided to appropriate buffers, switching to either a forward frame buffer 1041 or a backward frame buffer 1043. The digital video signal outputs from the forward frame buffer 1041 and the backward frame buffer 1043 are provided to the motion compensator 1021.

In an exemplary embodiment, the PSB frame decoder as shown in FIG. 10 is implemented by at least one processor; and at least one memory including computer program code; the at least one memory and the computer program code configured to, with the at least one processor, cause the apparatus to perform the PSB frame decoder's functions. There is at least one memory to store the data and act as buffers.

The one or more processors as referenced above are capable to receive input video signals from any means, for example, any wireless and wired communications channels or any storage devices such as magnetic drives, optical disc, solid states devices, etc. Each processor processes data as described by various non-limiting embodiments in the present application. Various processes are performed automatically with preset parameters or using programs stored in the one or more memory as mentioned above to control and input the parameters involved so the programs send control signals or data to the processors. While each processor also makes use of the memory to hold any intermediate data or output such as various types of video frames. Furthermore, any output is accessible by programs stored in the memory in case further processing is required by the processor and it is also possible to send the output to other devices or processors through any means such as communications channels or storage devices.

The description of preferred embodiments of this claimed invention are not exhaustive and any update or modifications to them are obvious to those skilled in the art, and therefore reference is made to the appending claims for determining the scope of this claimed invention. Although certain features may be described with reference to a particular embodiment, such features may be combined with features from the same or other embodiments unless explicitly stated otherwise.

### INDUSTRIAL APPLICABILITY

The claimed invention has industrial applicability in video communications, especially for encoding and decoding videos. For video communications, videos are required to be encoded before transmission over a channel to end users. The invention is particularly suitable for adoption in modern video coding standards such as H.264 and multi-view coding. The claimed invention can be implemented in software or devices providing a wide range of applications such as accessing a view from multi-view coding, transcoding MVC bitstream to AVC bitstream, random access, bitstream switching, and error resilience.

What is claimed is:

1. A method of digital video processing, comprising:
generating a reconstructed digital video frame according to motion-compensated prediction;
processing the reconstructed digital video frame with a transform, a quantization, a dequantization and an inverse transform to generate a digital video bitstream.

2. The method of digital video processing as claimed in claim 1, wherein:
the digital video bitstream is a multi-view video.

3. The method of digital video processing as claimed in claim 2, further comprising:
incorporating a SI frame into the multi-view video.

4. The method of digital video processing as claimed in claim 3, further comprising:
retrieving a single-view video bitstream in the multi-view video by obtaining a PSB frame in the multi-view video through the SI frame.

5. The method of digital video processing as claimed in claim 4, wherein:
the multi-view video has a MVC format.

6. The method of digital video processing as claimed in claim 5, wherein:
the single-view video bitstream has a H.264/AVC format.

7. The method of digital video processing as claimed in claim 4, further comprising:
modifying syntax of a multi-view video standard into syntax of a single-view video standard.

8. The method of digital video processing as claimed in claim 7, wherein:
the syntax of a single-view video standard is a syntax of H.264/AVC.

9. The method of digital video processing as claimed in claim 7, wherein:
the syntax of a multi-view video standard is a syntax of MVC.

10. The method of digital video processing as claimed in claim 1, further comprising:
providing a SI frame to access a frame in the digital video via a corresponding frame.

11. The method of digital video processing as claimed in claim 1, further comprising:
switching between two or more digital video bitstreams by using a PSB frame and a SSB frame.

12. A digital video processing apparatus, comprising:
at least one processor; and
at least one memory including computer program code;
the at least one memory and the computer program code configured to, with the at least one processor, cause the digital video processing apparatus to perform at least the following:
generating a reconstructed digital video frame according to motion-compensated prediction;
processing the reconstructed digital video frame with a transform, a quantization, a dequantization and an inverse transform to generate a digital video bitstream.

13. The digital video processing apparatus as claimed in claim 12, wherein:
the digital video processing apparatus further generates a SI frame and incorporates the SI frame into the digital video bitstream.

14. The apparatus of digital video processing apparatus as claimed in claim 13, wherein:
the digital video bitstream is a multi-view video.

15. The digital video processing apparatus as claimed in claim 14, wherein:
the digital video processing apparatus further retrieves a single-view video bitstream in the multi-view video by obtaining a PSB frame in the multi-view video through the SI frame.

16. The digital video processing apparatus as claimed in claim 15, wherein:
the multi-view video has a MVC format.

17. The digital video processing apparatus as claimed in claim 16, wherein:
the single-view video bitstream has a H.264/AVC format.

18. The digital video processing apparatus as claimed in claim 15, wherein:
the digital video processing apparatus further modifies syntax of a multi-view video standard into syntax of a single-view video standard.

19. The digital video processing apparatus as claimed in claim 12, wherein:
the digital video processing apparatus further accesses a frame in the digital video bitstream through the SI frame and a PSB frame.

20. The digital video processing apparatus as claimed in claim 12, wherein:
the digital video processing apparatus further switches between two or more digital video bitstreams by using a PSB frame and a SSB frame.
